(19) United States
(12) Patent Application Publication
(10) Pub. No.: US 2025/0092623 A1
(43) Pub. Date: Mar. 20, 2025

(54) ROLLER BRUSH OF WATER SURFACE CLEANING ROBOT

(71) Applicant: Taizhou Dibiao Technology Co., Ltd., Taizhou (CN)

(72) Inventor: Hua WANG, Taizhou (CN)

(73) Assignee: Taizhou Dibiao Technology Co., Ltd., Taizhou (CN)

(21) Appl. No.: 18/521,032

(22) Filed: Nov. 28, 2023

(30) Foreign Application Priority Data
Sep. 18, 2023 (CN) 202322536373.8
Sep. 18, 2023 (CN) 202322536683.X
Oct. 17, 2023 (CN) 202322785915.5

(51) Int. Cl. E02B 15/10; C02F 1/40; C02F 1/48; C02F 103/00

(52) U.S. Cl. CPC E02B 15/104; C02F 1/40; C02F 1/481; C02F 2103/007; C02F 2201/008

(57) ABSTRACT

A water surface cleaning robot includes a robot shell provided with a roller brush, two ends of the roller brush being connected with the robot shell, and a storage basket is arranged inside the robot shell. One side of the storage basket is provided with a baffle, a top portion of the storage basket is provided with an opening extending to the baffle, the roller brush is arranged above the baffle, the roller brush includes a plurality of blades, one end of the blade is provided with a hook, and the hook is oriented to one side entering water. Because the blade is provided with the hook, when the blade rotates to enter water, a contact area between the blade and a water surface is reduced, so that a resistance of the water surface to the blade is reduced, and a shoveling force generated by rotation is stronger.

### CROSS-REFERENCE TO RELATED APPLICATIONS

This application claims priority to Chinese Patent Application No. 202322785915.5, filed on Oct. 17, 2023; Chinese Patent Application No. 202322536373.8, filed on Sep. 18, 2023; and Chinese Patent Application No. 202322536683.X, filed on Sep. 18, 2023. All of the aforementioned applications are incorporated herein by reference in their entireties.

### TECHNICAL FIELD

The present application belongs to the technical field of cleaning devices, and relates to a roller brush of a water surface cleaning robot.

### BACKGROUND

With the development of science and technology, in order to clean garbage in water more conveniently and effectively, and prevent the garbage from polluting the water body, there is a water surface cleaning robot in the prior art. The water surface cleaning robot is used for cleaning garbage floating on a water surface, the robot moves forward under the driving of a driving device, and a roller brush at a front end of the robot may shovel the garbage in front into a basket. The cleaning of the garbage on the water surface in this way has higher efficiency and lower cost than manual cleaning, thus being suitable for works in different water areas.

However, there are still some shortcomings in the water surface cleaning robot in the prior art: the water surface cleaning robot mainly collects the garbage by the rotation of the roller brush to shovel external garbage into the basket, blades of the roller brush mainly have a straight plate structure in the prior art, and because the blades have the straight plate structure, when the blades rotate to enter the water, a contact area between the blades and the water surface is large, and the water surface may also absorb more rotating force on the blades while generating large waves, so that a shoveling force generated by the rotation of the roller brush is reduced, and garbage cleaning efficiency is decreased.

### SUMMARY

The application is intended to provide a roller brush of a water surface cleaning robot aiming at the problems in the prior art, and the technical problem to be solved by the application is how to increase a shoveling force and reduce waves generated by blades entering water.

The object of the application can be achieved by the following technical solution: a roller brush of a water surface cleaning robot is provided, the water surface cleaning robot includes a machine body, the machine body is provided with a roller brush, two ends of the roller brush are connected with the machine body, and a storage basket is arranged inside the machine body, wherein one side of the storage basket is provided with a baffle, a top portion of the storage basket is provided with an opening extending to the baffle, the roller brush is arranged above the baffle, the roller brush includes a plurality of blades, one end of the blade is provided with a hook, and when the blade entering the water surface, the hook is oriented to one side entering water.

In the solution, the robot is used for cleaning garbage floating on a water surface, after the robot is put in water, the robot may float on the water surface, the robot is driven to move forward by a power system on the robot, during the forward movement of the robot, the roller brush may also be driven to rotate, because the roller brush is arranged above the baffle, garbage on a path of the robot may be shoveled into the storage basket from the opening of the storage basket, and due to a blocking effect of the baffle, the garbage collected into the storage basket will not fall out of the storage basket; and because the blade is provided with the hook, when the blade rotates to enter the water, a contact area between the blade and the water surface is reduced, so that a resistance of the water surface to the blade is reduced. Therefore, compared with an ordinary blade, the blade with the hook has a higher rotation speed and a stronger shoveling force generated by rotation, when the blade enters the water, the hook at the front end of the blade may be in contact with the water surface first, so that the blade enters the water more smoothly, and compared with the ordinary blade which hits the water surface when entering the water, the blade with the hook generates smaller waves when entering the water.

In the roller brush of the water surface cleaning robot above, when the rotating blade is in contact with a water surface, an included angle between the hook and the water surface is 90 degrees, and a front end of the hook is a sharp angle. When the included angle between the hook and the water surface is 90 degrees, the hook enters the water surface vertically downwardly, and meanwhile, the sharp angle on the hook can make the blade more easily push away from the water surface, so that a resistance of entering the water is smaller.

In the roller brush of the water surface cleaning robot above, the blades on the roller brush are composed of a plurality of discontinuous single blade. The roller brush is composed of two or more sets of single blade, and the garbage on the water surface is shoveled by the single blade.

In the roller brush of the water surface cleaning robot above, the blades on the roller brush are composed of a plurality of continuous single-row blades, and two ends of the single-row blades extend to two ends of the roller brush. A spacing between the single-row blades is smaller, and a garbage shoveling frequency is higher.

In the roller brush of the water surface cleaning robot above, two ends of the roller brush are both provided with a clamping portion, and two sides of the machine body are both provided with a mounting portion corresponding to the clamping portion. The clamping portion is used for being connected with a structure on the mounting portion.

In the roller brush of the water surface cleaning robot above, the mounting portion includes a counterbore, a bottom portion of the counterbore is provided with a mounting hole, and the roller brush cooperates with the mounting hole through the clamping portion, so that the roller brush is hinged with the machine body. Because the clamping portion is hinged with the mounting hole, the roller brush may rotate on the machine body.

In the roller brush of the water surface cleaning robot above, a motor and a transmission gear are arranged inside the counterbore on one side, the motor is meshed with the transmission gear, and the transmission gear is fixedly connected with the clamping portion at one end. The motor and the transmission gear are both fixedly connected in the counterbore, the motor rotates to drive the meshed transmission gear to rotate, and because the transmission gear is fixedly connected with the clamping portion, the roller brush may be driven to rotate together.

In the roller brush of the water surface cleaning robot above, a front end of the water surface cleaning robot is provided with a water inlet and a water passing groove formed by penetrating through front and back portions, the water passing groove includes a mounting cavity located at the front end of the machine body, the storage basket is inserted into the mounting cavity from the front end, two sides of the storage basket are both provided with a mounting slider and a positioning pin, two side walls of the mounting cavity are both provided with a mounting supporting plate and a positioning supporting plate, the mounting supporting plate extends backward from the above water inlet in a water flowing direction, and when the mounting slider cooperates with the mounting supporting plate and abuts against a blocking portion of the mounting supporting plate, the positioning pin abuts against a positioning portion on the positioning supporting plate.

The storage basket is slidably connected with the mounting cavity of the water passing groove through the mounting slider and the mounting supporting plate, when the mounting slider is in contact with the blocking portion on the mounting supporting plate, the positioning pin on the storage basket is cooperatively connected with the positioning portion on the positioning supporting plate to avoid the storage basket from overturning, because the mounting supporting plate extends from the water inlet end to the rear end in a water flowing direction, and the mounting slider abuts against the blocking portion after finishing mounting, the storage basket can be mounted from the front end to avoid electric leakage caused by repeated opening and closing of a cover plate, and in the case of reducing a safety risk and prolonging a service life, the mounting supporting plate, the positioning supporting plate, the positioning pin on the storage basket and the mounting slider cooperate to avoid the storage basket from being separated from the machine body due to an influence of water flow, thus improving a mounting stability of the storage basket.

In the roller brush of the water surface cleaning robot above, the mounting supporting plate includes inclined insertion planes and a bearing plane, one ends of the inclined insertion planes are located at the water inlet, the other ends of the inclined insertion planes are connected with the bearing plane, and the bearing plane is capable of being arranged in parallel with a bottom surface of the storage basket and a ground surface. The storage basket is inserted into the mounting cavity from the water inlet of the machine body from bottom to top through the cooperation of the inclined insertion planes and the mounting slider, and then the storage basket is fixed by the bearing plane and corrected in position, so that the bottom surface of the storage basket is parallel to the ground surface to reduce a contact area of the storage basket during a movement of the device, thus further prolonging a service life of the device while reducing the resistance.

In the roller brush of the water surface cleaning robot above, the positioning supporting plate is provided with a guide plane and a clamping plane, the guide plane has a certain inclination, and the clamping plane is arranged in parallel with the bearing plane on the mounting supporting plate. The positioning pin is guided by the guide plane, so that a mounting difficulty of the storage basket is reduced and mounting efficiency is improved, and the clamping plane is parallel to the bearing plane, so that the storage basket is avoided from moving downward in the mounting cavity, and the mounting stability of the storage basket is improved.

In the roller brush of the water surface cleaning robot above, a partition plate is arranged on the water passing groove, the partition plate and a side wall of the water passing groove form the mounting cavity, and one end of the bearing plane is connected with the partition plate to form the blocking portion.

In the roller brush of the water surface cleaning robot above, the partition plate is provided with a magnetic adsorption sheet, and a storage basket rear wall is embedded with an absorption member placed opposite to the magnetic adsorption sheet. The magnetic adsorption sheet in magnetically adsorbed connection with the storage basket is arranged on the partition plate, so that the storage basket is automatically mounted when the mounting slider moves to the bearing plane, and a sound generated by collision between the mounting slider and the bearing plane can remind a user of in-place mounting of the device.

In the roller brush of the water surface cleaning robot above, the positioning supporting plate is located above the inclined insertion planes of the mounting supporting plate and close to the water inlet.

In the roller brush of the water surface cleaning robot above, a cover plate is arranged above the mounting cavity, the storage basket includes a storage basket side wall and a storage basket rear wall, the storage basket side walls cooperate to form a dumping port above the storage basket, and the cover plate completely covers the dumping port and cooperates with the storage basket to form a cavity with only a front-end opening. The cover plate completely covering the dumping port is arranged on the storage basket, so as to ensure that, when the storage basket is pulled out from the front end, the garbage will not be scattered outside the storage basket due to over-fullness, thus improving user experience.

In the roller brush of the water surface cleaning robot above, the water surface cleaning robot includes a water passing groove penetrating through front and back portions, a partition plate is arranged in the water passing groove, the partition plate and inner walls on two sides of the water passing groove cooperate to form a mounting cavity, a front end of the mounting cavity is provided with an inlet for inserting the storage basket, the storage basket is provided with a fixing assembly and a positioning assembly, and the storage basket is inserted into the mounting cavity from the above inlet in a water flowing direction, so that the fixing assembly is connected with the partition plate in an inserted manner, and the positioning assembly is connected with an adsorption portion on an inner wall of the mounting cavity in an adsorbed manner.

The machine body includes the water passing groove penetrating through front and back portions, and the roller brush and the storage basket are arranged at the front end of the water passing groove, so that the garbage can be collected into the storage basket during the movement process of the machine body; the partition plate is arranged on the water passing groove, and the fixing assembly of the storage basket is connected with the partition plate in the inserted manner, so that a certain blocking effect is achieved, and the machine body is avoided from moving forward by a driver and the storage basket is avoided from moving backward or staying still under an influence of the roller brush; the storage basket is connected with the partition plate in the inserted manner through the fixing assembly, and a relative position of the storage basket is corrected by the adsorbed connection between the positioning assembly and the inner walls on two sides of the mounting cavity after the inserted connection, so that the garbage collected by the storage basket is avoided from being dumped out due to influences of a water flow or other factors in the use process, and a use stability of the water surface cleaning machine is improved; because a way of inserting from a collection port at the front end of the machine body is used, a structure of the machine body is simplified, and a service life of the power supply system is avoided from being shortened due to repeated opening and closing of the upper cover; and the storage basket only needs to move relative to the mounting cavity for a certain distance in an opposite direction of water flow, so as to separate the fixing assembly from the partition plate, and the positioning assemblies are dislocated from the adsorption portions on two sides of the mounting cavity, so that a mounting structure is simplified, thus improving the mounting efficiency.

In the roller brush of the water surface cleaning robot above, the fixing assembly includes mounting pins located on a storage basket rear wall and symmetrically placed Medium the partition plate is provided with mounting holes corresponding to the mounting pins. The mounting pin on the storage basket rear wall is in clamped connection with the mounting hole in the partition plate, so as to improve a connection reliability between the storage basket and the machine body while avoiding the storage basket from moving backward under the influence of water flow.

In the roller brush of the water surface cleaning robot above, the positioning assembly includes a magnetic adsorption sheet or an iron sheet located on a storage basket side wall, the magnetic adsorption sheet or the iron sheet is embedded above the storage basket and close to a water inlet, and the adsorption portions located on the inner walls on two sides of the mounting cavity correspond to the magnetic adsorption sheets or the iron sheets above one by one. The positioning assembly located at the front end ensures that the internal garbage will not be dumped out from the front end because the front end of the storage basket is not positioned during a movement process of the device.

In the roller brush of the water surface cleaning robot above, the positioning assembly further includes a magnetic adsorption sheet or an iron sheet located on a storage basket rear wall, the magnetic adsorption sheet or the iron sheet above is located between two mounting pins, and the partition plate is provided with the adsorption portion corresponding to the magnetic adsorption sheet or the iron sheet above. The adsorption portion cooperates with the magnetic adsorption sheet or the iron sheet while inserting the mounting pin into the partition plate to connect the adsorption portion with the magnetic adsorption sheet or the iron sheet, so that a connection strength between the storage basket and the machine body is further improved.

In the roller brush of the water surface cleaning robot above, one end of the storage basket extends forward to a position below the roller brush located at the front end of the machine body to form a pocket portion, and a concave pull handle is integrally formed on the pocket portion. The pocket portion is arranged below the roller brush, which avoids the garbage from falling out of the storage basket in a garbage recycling process, and the concave pull handle can also be arranged at the pocket portion, which is convenient for the user to unload the storage basket for subsequent dumping work.

In the roller brush of the water surface cleaning robot above, the front end of the machine body is provided with two mutually symmetrical inclined planes, and the inclined planes cooperate with a pull handle and a pocket portion to form a trapezoid with a large outer portion and a small inner portion. The water inlet cooperates with an inlet of the storage basket to form the trapezoid, so that the garbage on the water surface can be guided to a certain extent, thus further improving the recycling efficiency.

Compared with the prior art, the application has the following advantages.

In the solution, because the blade is provided with the hook, when the blade rotates to enter the water, the included angle between the hook and the water surface is 90 degrees, so that the contact area between the blade and the water surface is reduced, and the resistance generated by the water surface is reduced, and compared with an ordinary blade, the blade with the hook has a higher rotation speed and a stronger shoveling force generated by rotation at the same time.

In the solution, when the blade enters the water, the hook at the front end of the blade may be in contact with the water surface first, so that the blade enters the water more smoothly, and compared with the ordinary blade which hits the water surface when entering the water, the blade with the hook generates smaller waves when entering the water.

In the solution, the storage basket is mainly inserted from the water inlet end of the machine body, and the mounting sliders and the positioning pins located on two side walls of the storage basket cooperate with the mounting supporting plates and positioning supporting plates on two sides of the mounting cavity, so that the fixation of the storage basket is finished, and the mounting supporting plates extend from the water inlet to the rear end and cooperate with the partition plate to form the blocking portion, so as to avoid the storage basket from being separated from the machine body during the movement process, thus improving the stability.

In the case of cooperative connection between the mounting slider and the positioning pin, the storage basket is connected with the partition plate through the magnetic adsorption assembly, and the cover plate is covered on the storage basket, so as to avoid a difficulty of taking out the storage basket from the front side due to over-fullness of internal garbage.

In the solution, the storage basket is mainly inserted into the machine body from the water inlet at the front end of the machine body in the water flowing direction, and the recycling and mounting of the storage basket are completed by pulling, wherein the storage basket is positioned by the cooperation of the magnetic adsorption sheets or the iron sheets and the adsorption portions on the inner walls on two sides of the mounting cavity while fixing the storage basket with the mounting hole in the partition plate through the mounting pin, so as to improve the convenience of disassembling the storage basket by magnetic adsorption while avoiding the collected garbage from being dumped back into the water again.

The positioning assemblies are respectively arranged on the storage basket side wall and the storage basket rear wall, so as to further improve the stability of the storage basket while ensuring that the storage basket will not move.

### BRIEF DESCRIPTION OF THE DRAWINGS

FIG. 1 is a schematic diagram of a stereoscopic structure of the application.

FIG. 2 is a schematic diagram of a stereoscopic structure of a hidden cover plate of the application.

FIG. 3 is a schematic diagram of a stereoscopic exploded structure and a local enlarged structure of the application.

FIG. 4 is a schematic structural diagram of a roller brush composed of single blade of the application.

FIG. 5 is a schematic structural diagram of a roller brush of single-row blades in Second Embodiment of the application.

FIG. 6 is a schematic diagram of an exploded structure of a hidden roller brush of the application.

FIG. 7 is a cross-sectional diagram from a top view of the application.

FIG. 8 is a right cross-sectional view of an A-A part in FIG. 7 of the application.

FIG. 9 is a left cross-sectional view of a B-B part in FIG. 7 of the application.

FIG. 10 is a schematic diagram of an exploded structure in Third Embodiment of the application.

FIG. 11 is a cross-sectional diagram from a top view in Third Embodiment of the application.

FIG. 12 is a left cross-sectional view in Third Embodiment of the application mounted with a storage basket.

FIG. 13 is a left cross-sectional view in Third Embodiment of the application without mounting the storage basket.

### DETAILED DESCRIPTION OF THE EMBODIMENTS

The following descriptions are specific embodiments of the application, and with reference to the drawings, technical solutions of the application are further described, but the application is not limited to these embodiments.

### First Embodiment

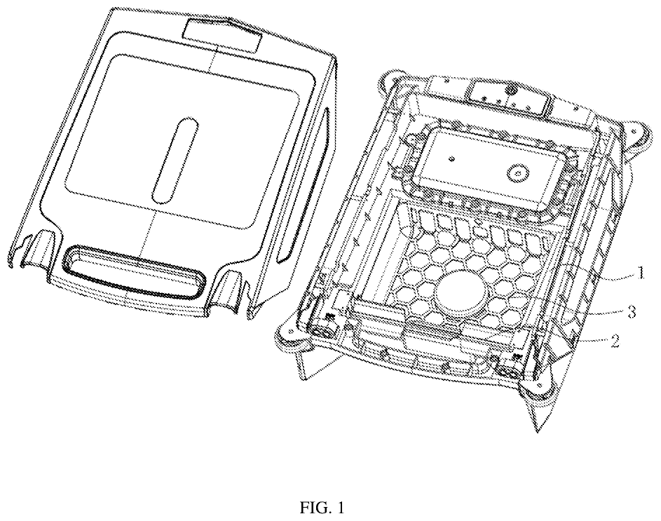

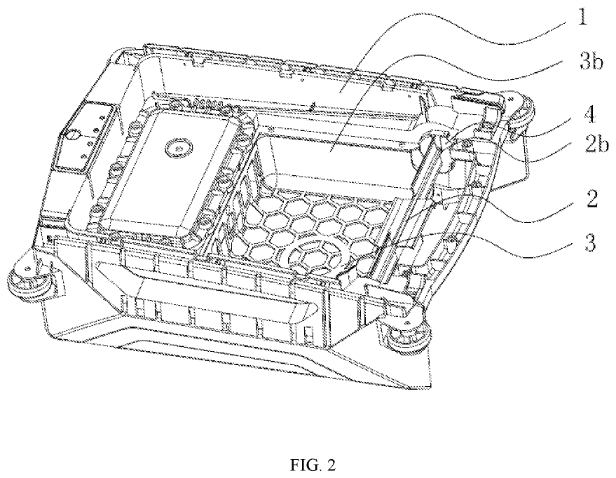

As shown in FIG. 1 and FIG. 2, according to a roller brush 2 of a water surface cleaning robot, the water surface cleaning robot includes a machine body 1, a front end of the machine body 1 is provided with a storage basket 3, a top portion of the storage basket 3 is provided with an opening 3b, two sides of an interior of the machine body are provided with symmetrical mounting portions 4, the mounting portion 4 is hinged with the roller brush 2, and two ends of the roller brush 2 are both provided with a clamping portion 2b.

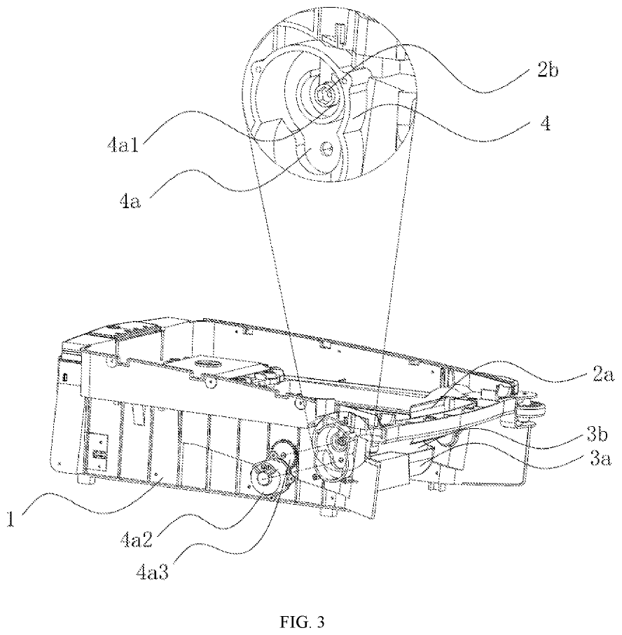

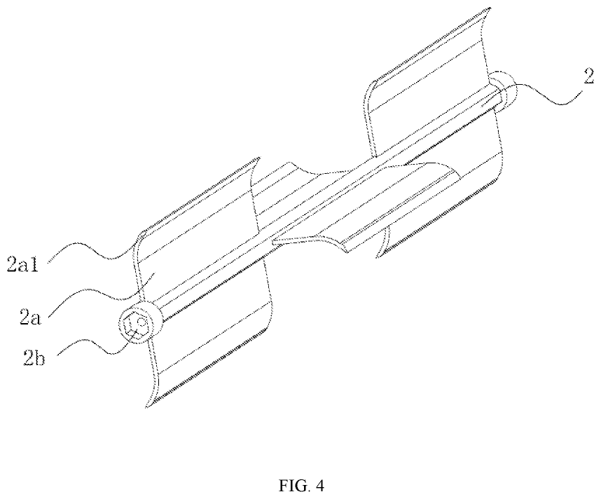

As shown in FIG. 3 and FIG. 4, one side of the storage basket 3 oriented to the front end of the machine body 1 is provided with a baffle 3a, the opening 3b extends to a position above the baffle 3a, the roller brush 2 is arranged above the baffle 3a and on an outer side the opening 3b. The roller brush 2 includes a plurality of blades 2a, the blades 2a on the roller brush 2 are composed of a plurality of discontinuous single blade 2a, the other end of the blade 2a connected with the roller brush 2 is provided with a hook 2a1, and a front end of the hook 2a1 is a sharp angle. The mounting portion 4 includes a counterbore 4a, a bottom portion of the counterbore 4a is provided with a mounting hole 4a1, and the roller brush 2 cooperates with the mounting hole 4a1 through the clamping portion 2b and is hinged with the machine body 1. A motor 4a2 and a transmission gear 4a3 which are fixedly connected are arranged inside the counterbore 4a, the motor 4a2 is meshed with the transmission gear 4a3, and the transmission gear 4a3 is fixedly connected with the clamping portion 2b.

As shown in FIG. 1 to FIG. 4, after the robot is put into water, the robot may float on a water surface, and the robot is driven to move forward by a power system on the robot. During the forward movement of the robot, the motor 4a2 rotates to drive the meshed transmission gear 4a3 to rotate, and because the transmission gear 4a3 is fixedly connected with the clamping portion 2b, the roller brush 2 is driven to rotate together. Because the roller brush 2 is arranged above the baffle 3a and located at the opening 3b of the storage basket 3, the blade 2a on the roller brush 2 may shovel garbage on a path of the robot into the storage basket 3 from the opening 3b of the storage basket 3. Due to a blocking effect of the baffle 3a, the garbage collected into the storage basket 3 will not fall out of the storage basket 3 again, thus achieving the function of cleaning the garbage on the water surface.

Because the blade 2a is provided with the hook 2a1 and the front end of the hook 2a1 is the sharp angle, when the blade 2a rotates to enter the water, an included angle between the hook 2a1 and the water surface is 90 degrees, so that a contact area between the blade 2a and the water surface is reduced, and a resistance generated by the water surface to the blade 2a is reduced. Therefore, compared with an ordinary blade 2a, the blade 2a with the hook 2a1 has a higher rotation speed and a stronger shoveling force generated by rotation. Moreover, when the blade 2a enters the water, the hook 2a1 at the front end of the blade 2a may be in contact with the water surface first, so that the blade 2a enters the water more easily, and compared with the ordinary blade 2a which hits the water surface when entering the water, the blade 2a with the hook 2a1 generates smaller waves when entering the water.

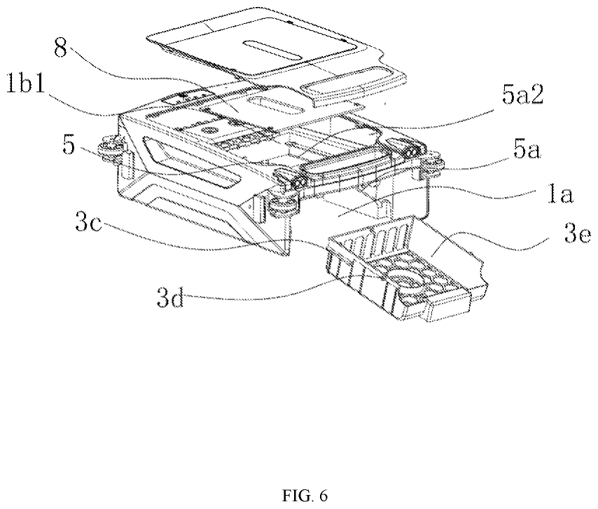

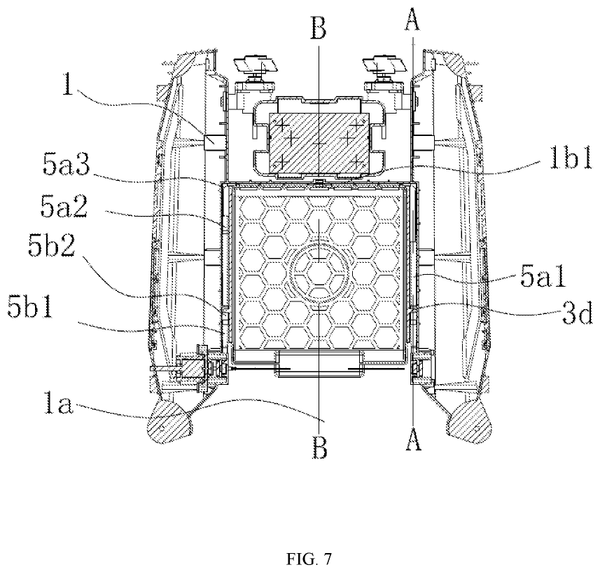

As shown in FIG. 6 and FIG. 7, the present application is a storage apparatus of a water surface cleaning device, which includes a machine body 1 and a storage basket 3 inserted from a water inlet 1a of the machine body 1, wherein the storage basket 3 is provided with a positioning pin 3d and a mounting slider 3c, the positioning pin 3d is located at a front end of the storage basket 3, the mounting slider 3c is located at a rear end of the storage basket 3, and the positioning pin 3d is located above the mounting slider 3c. A water passing groove 1b on the machine body 1 is separated by a partition plate 1b1 to form a mounting cavity 5, two side walls of the mounting cavity 5 are both provided with a mounting supporting plate 5a and a positioning supporting plate 5b, the mounting supporting plate 5a includes inclined insertion planes 5a1 and a bearing plane 5a2, and the positioning supporting plate 5b includes a guide plane 5b1 and a clamping plane 5b2. The partition plate 1b1 is provided with a magnetic adsorption sheet 6, a storage basket rear wall 3h in the storage basket 3 is provided with an absorption member 7 absorbed with the magnetic adsorption sheet 6, and the mounting supporting plate 5a extends from the water inlet 1a to the rear end. After the storage basket 3 is inserted into the mounting cavity 5, the mounting slider 3c is located on the bearing plane 5a2, and abuts against a blocking portion 5a3 formed by the cooperation of the partition plate 1b1 and the bearing plane 5a2.

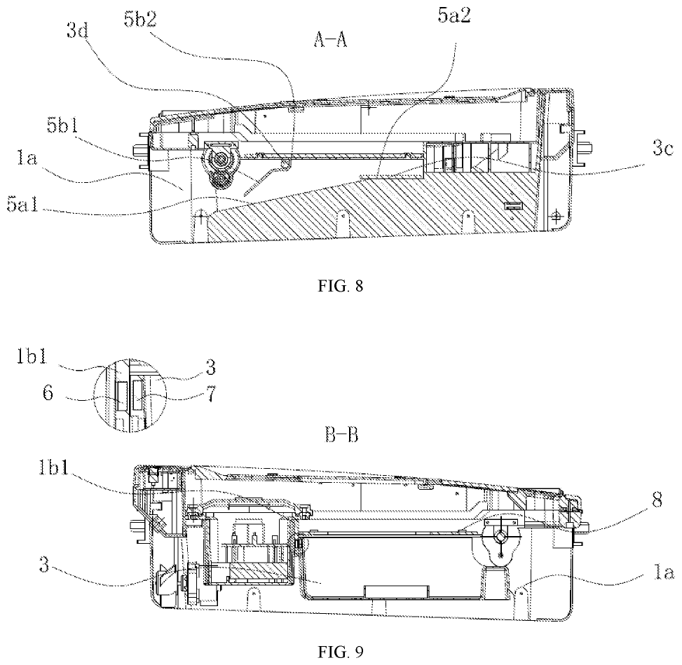

As shown in FIG. 8 and FIG. 9, after the storage basket 3 is inserted into the mounting cavity 5 from the front end, a cover plate 8 located in the machine body 1 can completely cover the storage basket 3, and cooperates with the storage basket side wall 3i in the storage basket 3 to form a sealed space with only a front end opening 3b, the storage basket rear wall 3h in the storage basket 3 is provided with the absorption member 7 connected with the magnetic adsorption sheet 6 on the partition plate 1b1, and the storage basket 3 is connected with the mounting cavity 5 through the mounting supporting plate 5a and the positioning supporting plate 5b located on the side wall, wherein the positioning pin 3d and the mounting slider 3c on the storage basket 3 are respectively in contact with the mounting supporting plate 5a and the positioning supporting plate 5b. The mounting supporting plate 5a includes the inclined insertion planes 5a1 and the bearing plane 5a2, the positioning supporting plate 5b includes a supporting plate with a certain inclination and the clamping plane 5b2 parallel to a ground surface, and the positioning supporting plate 5b is located at the water inlet 1a of the water passing groove 1b of the machine body 1.

The mounting slider 3c at the rear end of the storage basket 3 is in contact with the mounting supporting plate 5a located on the water inlet 1a of the machine body 1, and the mounting slider 3c moves toward the partition plate 1b1 along the inclined insertion planes 5a1 on the mounting supporting plate 5a, and then abuts against the blocking portion 5a3 formed by the cooperation of the bearing plane and the partition plate 1b1. When the mounting slider 3c is in contact with the inclined insertion planes 5a1, the positioning pin 3d on the storage basket 3 is in contact with the guide plane 5b1 on the positioning supporting plate 5b, and in the case that the mounting slider 3c abuts against the blocking portion 5a3, the positioning pin 3d is in contact with the clamping plane 5b2 on the positioning supporting plate 5b, so as to abut against a positioning portion 5b3. The mounting supporting plate 5a and the positioning supporting plate 5b both extend from the water inlet 1a provided with the roller brush 2 on the machine body 1 in an opposite direction of movement of the water surface cleaning device, and the mounting supporting plate 5a and the partition plate 1b1 for separating the water passing groove 1b cooperate to form the blocking portion 5a3, so that the storage basket 3 is avoided from being separated from the machine body 1 due to an influence of water flow during the movement of the water surface cleaning device. Moreover, the positioning pin 3d is arranged at the front end of the storage basket 3, and the positioning pin 3d cooperates with the positioning supporting plate 5b, so that the front end of the storage basket 3 and a groove wall of the water passing groove 1b can cooperate to form the opening 3b for accommodating the roller brush 2 and allowing the garbage to enter the storage basket 3. When the storage basket 3 is inserted into the mounting cavity 5 from the water inlet 1a at the front end to reduce a safety risk of electric leakage and prolong a service life of the device, the storage basket is fixed by the cooperation of the storage basket 3 and the mounting cavity 5, so as to avoid the collected garbage from being dumped out due to the overturning of the storage basket 3 while ensuring that the storage basket can be taken out normally.

In order to facilitate an operator to pull out the storage basket 3 without garbage scattered out during the pulling process, the cover plate 8 is arranged on the dumping port 3e surrounded by the storage basket side wall 3i of the storage basket 3, and the cover plate 8 completely covers the dumping port 3e, so as to avoid an interference with a rolling member due to excessive garbage, thus improving use experience.

### Second Embodiment

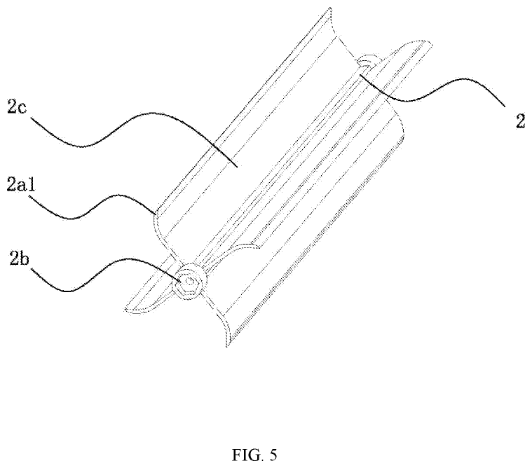

This embodiment is an alternative to First Embodiment, in which connection structures between the machine body 1 and the roller brush 2 are all the same as those in First Embodiment, except for the structure of the blade 2a of the roller brush 2. As shown in FIG. 5, the roller brush 2 in this embodiment is composed of a plurality of single-row blades 2c, and one end of the single-row blade 2c far away from the roller brush 2 is provided with a hook 2a1 with the same structure as that in First Embodiment.

### Third Embodiment

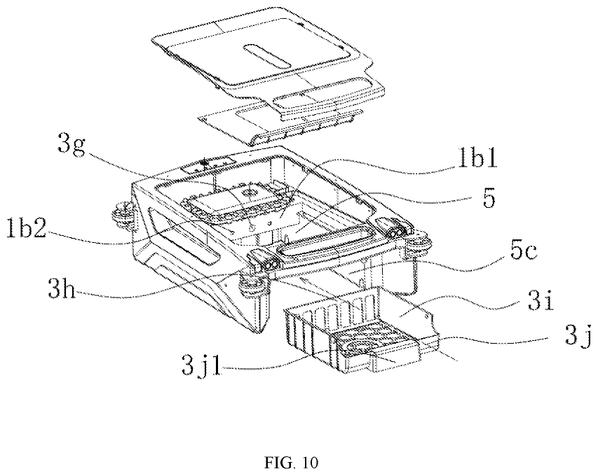

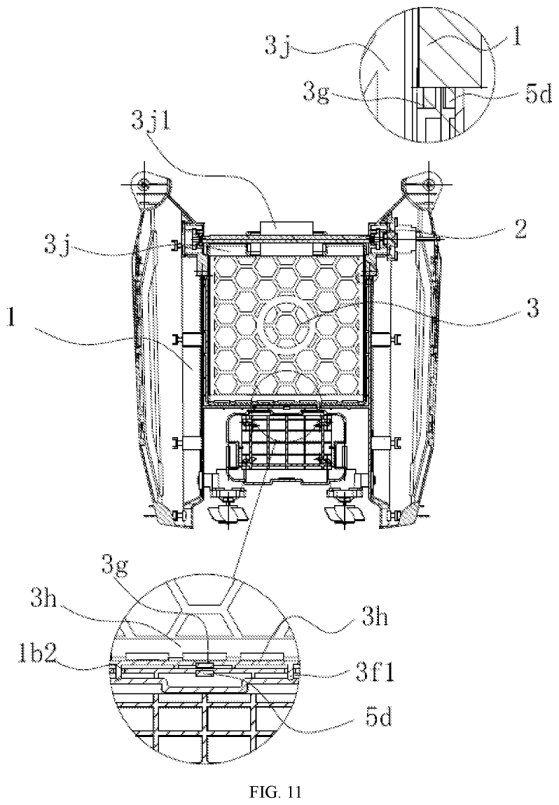

As shown in FIG. 10 and FIG. 11, the present application is a storage apparatus of a water surface cleaning machine, the water surface cleaning machine includes a machine body 1 and a storage basket 3 inserted from a water inlet 1a of the machine body 1, wherein the machine body 1 is provided with a mounting cavity 5 for accommodating the storage basket 3, and the mounting cavity 5 is formed by the cooperation of an inner wall of the machine body 1 and a partition plate 1b1 located on the machine body 1. The partition plate 1b1 is provided with a mounting hole 1b2 for fixing the storage basket 3, the storage basket 3 and the partition plate 1b1 are fixed by the cooperation of a mounting pin 3f1 on a fixing assembly 3f and the mounting hole 1b2, the mounting pin 3f1 is located on a storage basket rear wall 3h in the storage basket 3, and the storage basket rear wall 3h and two storage basket side walls 3i in the storage basket 3 are all provided with a positioning assembly 3g which is a magnetic adsorption sheet or an iron sheet, wherein the positioning assemblies 3g located on the two storage basket side walls 3i of the storage basket 3 are close to the roller brush 2, the positioning assembly 3g located on the storage basket rear wall 3h of the storage basket 3 is located between the two mounting pins 3f1, and an adsorption portion 5d in adsorbed connection with the positioning assembly 3g is arranged between two mounting holes 1b2 in the partition plate 1b1. Moreover, a pocket portion 3j is arranged right below the roller brush 2, the pocket portion 3j is provided with a pull handle 3j1, and the pull handle 3j1 and two inclined planes 1c at an inlet 5c of the machine body 1 cooperate to form an inverted trapezoid.

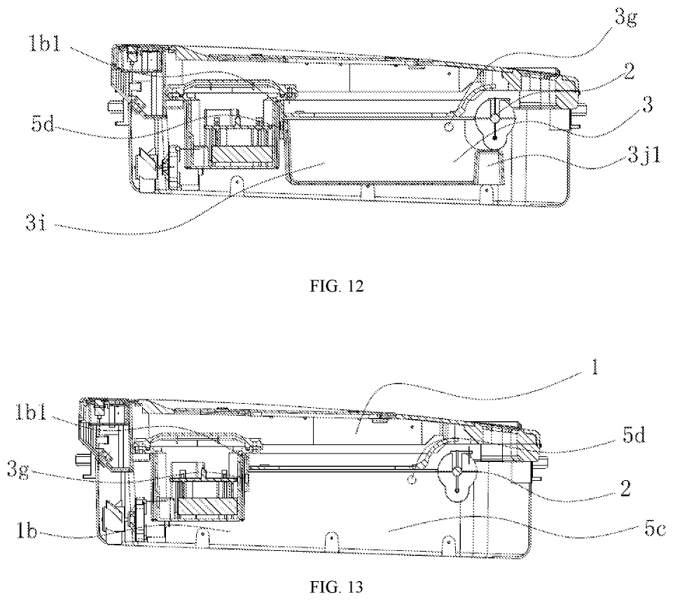

As shown in FIG. 12 and FIG. 13, the machine body 1 in the solution is also provided with a water passing groove 1b penetrating through front and back portions, the partition plate 1b1 is located in the water passing groove 1b and separates the water passing groove 1b to obtain the mounting cavity 5 for mounting the storage basket 3, and two sides of the mounting cavity 5 are both provided with the adsorption portion 5d, so that the machine body 1 can be connected with the storage basket 3 in an adsorbed manner. When the storage basket 3 enters the mounting cavity 5 from the inlet 5c at the front end of the machine body 1 in a water flowing direction, the mounting pin 3f1 on the storage basket rear wall 3h of the storage basket 3 is connected with the mounting hole 1b2 in the partition plate 1b1 in an inserted manner, and the positioning assembly 3g on the storage basket rear wall 3h of the storage basket 3 is connected with the adsorption portion 5d on the partition plate 1b1 in an adsorbed manner. A front end of the storage basket 3 (which is namely the water inlet 1a) is provided with the pocket portion 3j, the pocket portion 3j is provided with the concave pull handle 3j1, and a length of the pocket portion 3j is greater than a radius of the roller brush 2.

The storage basket 3 is inserted into the water passing groove 1b from the inlet 5c at the front end of the machine body 1, and the storage basket 3 is fixed through the mounting cavity 5 formed by the cooperation of the partition plate 1b1 on the water passing groove 1b and inner walls on two sides of the water passing groove, wherein the mounting pin 3f1 on the storage basket rear wall 3h in the storage basket 3 is connected with the mounting hole 1b2 in the partition plate 1b1 in an inserted manner while mainly connecting the storage basket side walls 3i in the storage basket 3 with the mounting cavity 5 through the positioning assemblies 3g and the adsorption portions 5d on two sides of the mounting cavity 5 in an adsorbed manner, and the positioning assembly 3g placed between two mounting pins 3f1 is connected with the adsorption portion 5d on the partition plate 1b1 in the adsorbed manner. In the case of ensuring the accurate mounting of the storage basket 3 and avoiding the garbage collected inside from being dumped out due to mounting dislocation, the storage basket is fixed by connecting the mounting pin 3f1 with the mounting hole 1b2 in the inserted manner, and under the cooperation with the partition plate 1b1, the storage basket 3 is avoided from moving backward due to an influence of water flow during the movement of the water surface cleaning machine, so that the adsorption portions 5d on the machine body 1 are dislocated from the positioning assemblies 3g on the storage basket 3 to cause the storage basket 3 to fall out. Moreover, the positioning assembly 3g and the adsorption portion 5d are both made of a magnetic material such as the magnetic adsorption sheet or the iron sheet embedded in the storage basket 3 and the side wall of the machine body 1 respectively, so that when the storage basket 3 moves to a certain position from the front end to the rear end of the machine body 1 in the water flowing direction, the positioning assembly 3g is in magnetically adsorbed connection with the adsorption portion 5d, thus simplifying a mounting mode of the storage basket 3, improving use experience, and prolonging a service life of the device by pulling forward.

In order to ensure recycling efficiency of the water surface cleaning machine, the pocket portion 3j located right below the roller brush 2 is arranged on the storage basket 3, and cooperates with symmetrical inclined planes 1c on two sides of the machine body 1 to form a trapezoid, so as to guide the garbage to a certain extent. Moreover, the pocket portion 3j is provided with a concave pull handle 3j1, and an operator completes the mounting of the machine body 1 by the pull handle 3j1.

The specific embodiments described herein are only illustrative to the spirit of the application. Those skilled in the technical field to which the application belongs may make various modifications or supplements to the specific embodiments described or make substitutions in a similar way, without departing from the spirit of the application or exceeding the scope defined by the appended claims.

Although the terms machine body 1, roller brush 2, blade 2a, hook 2a1, clamping portion 2b, storage basket 3, baffle 3a, opening 3b, mounting portion 4, counterbore 4a, mounting hole 4a1, motor 4a2, transmission gear 4a3, and the like are frequently used herein, the possibility of using other terms is not excluded. These terms are only used to describe and explain the essence of the application more conveniently; and the explanation of the terms as any additional restriction is against the spirit of the application.

What is claimed is:

1. A roller brush of a water surface cleaning robot, wherein the water surface cleaning robot comprises:
a machine body, the machine body being provided with a roller brush, two ends of the roller brush being connected with the machine body; and
a storage basket, the storage basket being arranged inside the machine body; wherein
one side of the storage basket is provided with a baffle, a top portion of the storage basket is provided with an opening extending to the baffle, the roller brush is arranged above the baffle;
the roller brush comprises a plurality of blades;
one end of the blade is provided with a hook; and
when the blade enters the water surface, the hook is oriented to one side entering water.

2. The roller brush of the water surface cleaning robot according to claim 1, wherein when the rotating blade is in contact with a water surface, an included angle between the hook and the water surface is 90 degrees, and a front end of the hook is a sharp angle.

3. The roller brush of the water surface cleaning robot according to claim 1, wherein the blades on the roller brush are composed of a plurality of discontinuous single blade.

4. The roller brush of the water surface cleaning robot according to claim 1, wherein the blades on the roller brush are composed of a plurality of continuous single-row blades, and two ends of the single-row blades extend to two ends of the roller brush.

5. The roller brush of the water surface cleaning robot according to claim 1, wherein two ends of the roller brush are both provided with a clamping portion, and two sides of the machine body are both provided with a mounting portion corresponding to the clamping portion.

6. The roller brush of the water surface cleaning robot according to claim 5, wherein the mounting portion comprises a counterbore, a bottom portion of the counterbore is provided with a mounting hole, and the roller brush cooperates with the mounting hole through the clamping portion, so that the roller brush is hinged with the machine body.

7. The roller brush of the water surface cleaning robot according to claim 6, wherein a motor and a transmission gear are arranged inside the counterbore on one side, the motor is meshed with the transmission gear, and the transmission gear is fixedly connected with the clamping portion at one end.

8. The roller brush of the water surface cleaning robot according to claim 1, wherein a front end of the water surface cleaning robot is provided with a water inlet and a water passing groove formed by penetrating through front and back portions, the water passing groove comprises a mounting cavity located at the front end of the machine body, the storage basket is inserted into the mounting cavity from the front end, two sides of the storage basket are both provided with a mounting slider and a positioning pin, two side walls of the mounting cavity are both provided with a mounting supporting plate and a positioning supporting plate, the mounting supporting plate extends backward from the above water inlet in a water flowing direction, and when the mounting slider cooperates with the mounting supporting plate and abuts against a blocking portion of the mounting supporting plate, the positioning pin abuts against a positioning portion on the positioning supporting plate.

9. The roller brush of the water surface cleaning robot according to claim 8, wherein the mounting supporting plate comprises inclined insertion planes and a bearing plane, one ends of the inclined insertion planes and are located at the water inlet, the other ends of the inclined insertion planes are connected with the bearing plane, and the bearing plane is capable of being arranged in parallel with a bottom surface of the storage basket and a ground surface.

10. The roller brush of the water surface cleaning robot according to claim 9, wherein the positioning supporting plate is provided with a guide plane and a clamping plane, the guide plane has a certain inclination, and the clamping plane is arranged in parallel with the bearing plane on the mounting supporting plate.

11. The roller brush of the water surface cleaning robot according to claim 10, wherein a partition plate is arranged on the water passing groove, the partition plate and a side wall of the water passing groove form the mounting cavity, and one end of the bearing plane is connected with the partition plate to form the blocking portion.

12. The roller brush of the water surface cleaning robot according to claim 11, wherein the partition plate is provided with a magnetic adsorption sheet, and a storage basket rear wall is embedded with an absorption member placed opposite to the magnetic adsorption sheet.

13. The roller brush of the water surface cleaning robot according to claim 8, wherein the positioning supporting plate is located above the inclined insertion planes and of the mounting supporting plate and close to the water inlet.

14. The roller brush of the water surface cleaning robot according to claim 8, wherein a cover plate is arranged above the mounting cavity, the storage basket comprises a storage basket side wall and a storage basket rear wall, the storage basket side walls cooperate to form a dumping port above the storage basket, and the cover plate completely covers the dumping port and cooperates with the storage basket to form a cavity with only a front-end opening.

15. The roller brush of the water surface cleaning robot according to claim 1, wherein the water surface cleaning robot comprises a water passing groove penetrating through front and back portions, a partition plate is arranged in the water passing groove, the partition plate and inner walls on two sides of the water passing groove cooperate to form a mounting cavity, a front end of the mounting cavity is provided with an inlet for inserting the storage basket, the storage basket is provided with a fixing assembly and a positioning assembly, and the storage basket is inserted into the mounting cavity from the above inlet in a water flowing direction, so that the fixing assembly is connected with the partition plate in an inserted manner, and the positioning assembly is connected with an adsorption portion on an inner wall of the mounting cavity in an adsorbed manner.

16. The roller brush of the water surface cleaning robot according to claim 15, wherein the fixing assembly comprises mounting pins located on a storage basket rear wall and symmetrically placed, and the partition plate is provided with mounting holes corresponding to the mounting pins.

17. The roller brush of the water surface cleaning robot according to claim 16, wherein the positioning assembly comprises a magnetic adsorption sheet or an iron sheet located on a storage basket side wall, the magnetic adsorption sheet or the iron sheet is embedded above the storage basket and close to a water inlet, and the adsorption portions located on the inner walls on two sides of the mounting cavity correspond to the magnetic adsorption sheets or the iron sheets above one by one.

18. The roller brush of the water surface cleaning robot according to claim 17, wherein the positioning assembly further comprises a magnetic adsorption sheet or an iron sheet located on a storage basket rear wall, the magnetic adsorption sheet or the iron sheet above is located between two mounting pins, and the partition plate is provided with the adsorption portion corresponding to the magnetic adsorption sheet or the iron sheet above.

19. The roller brush of the water surface cleaning robot according to claim 15, wherein one end of the storage basket extends forward to a position below the roller brush located at the front end of the machine body to form a pocket portion, and a concave pull handle is integrally formed on the pocket portion.

20. The roller brush of the water surface cleaning robot according to claim 15, wherein the front end of the machine body is provided with two mutually symmetrical inclined planes, and the inclined planes cooperate with a pull handle and a pocket portion to form a trapezoid with a large outer portion and a small inner portion.
